(19) United States
(12) Patent Application Publication
(10) Pub. No.: US 2003/0034288 A1
(43) Pub. Date: Feb. 20, 2003

(54) Universal fit filter

(76) Inventor: Shawn Michael Stover, Louisville, KY (US)

Correspondence Address: John S. Beulick, Armstrong Teasdale LLP, Suite 2600, One Metropolitan Square, St. Louis, MO, 63102, US

(21) Appl. No.: 09/753,390

(22) Filed: Dec. 29, 2000

Related U.S. Application Data
(60) Provisional application No. 60/201,094, filed on May 2, 2000.

(51) Int. Cl. B01D 27/00

(52) U.S. Cl. 210/232; 210/435; 210/497.01

(57) ABSTRACT

In an exemplary embodiment the replaceable filter 120 comprises a subassembly including a closed outer cylindrical filter 122 having a top 117 a bottom 119, and a side wall defining a chamber 121 therein. There is next a first end cap 129 fixed to the filter top 117. The first end cap 129 includes a first outlet port 127 having a wall section 128 being coupled at one end to the first outlet port 127 and extends into said chamber 121 and sized to encompass the water outlet flange 104 and the guide flange 108. The replaceable filter 120 also has a second end cap 131, substantially equal to the first end cap 129, fixed to said filter bottom 119. The second end cap 131 also includes a second outlet port 125 having a wall section 130 being coupled at one end to the second outlet port 125 and extending into the filter chamber 121. The second end cap wall 130 is sized to encompass the guide flange 108 and alternatively the water outlet flange 104. Next, a first compression gasket 124 is glued to or otherwise fixed to the outer surface of the first end cap 129. The first gasket 124 is arranged to make a water tight seal with the water outlet seal surface 106 and the guide flange seal surface 110 of the filter housing 100. A second compression gasket 126 is fixed to the outer surface of the second end cap 131. The second gasket 126 is adapted to make a water tight seal with the guide flange seal surface 110 and alternatively with the water outlet seal surface 106 of the filter housing 100. The filter cartridge 120 further may be installed within the filter housing 100 in any one of two orientations including the filter top side 117 up and alternatively the filter bottom side 119 up.

### CROSS REFERENCE TO RELATED APPLICATIONS

This application claims the benefit of U.S. provisional application No. 60/201,094, filed on May 2, 2000.

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights.

### BACKGROUND OF THE INVENTION

The present invention relates to a residential water filter system and more particularly to a replaceable water filter for a standard ten inch water filter housing.

It is well known in the art to provide a replacement water filter cartridge in residential water purification systems. One such example is illustrated in U.S. Pat. No. 4,626,350, Reid. Reid illustrates an example of a single-directional water flow filter. If the filter is installed backwards unfiltered water may be delivered to the user. Further if the filter is improperly sized it will not fit a ten inch standard housing. It would be desirable to have a replacement filter that solved these problems.

### BRIEF SUMMARY OF THE INVENTION

In an exemplary embodiment the replaceable filter of the present invention comprises a subassembly including a closed outer cylindrical filter element having a top, a bottom, and a side wall defining a chamber therein. A first end cap is fixed to the filter top wall. The first end cap includes a first inlet port having a wall section being coupled at one end to the first inlet port and extends into the filter chamber and is sized to encompass the water outlet flange and the guide flange of a filter housing. The replaceable filter also has a second end cap, substantially equal to the first end cap, fixed to said filter bottom wall. A second end cap is attached to the bottom of the cylindrical filter and also includes a second inlet port having a wall section being coupled at one end to the second inlet port and extends into the filter chamber. The second end cap wall section is sized to encompass the guide flange and alternatively the water outlet flange. Next, a first compression gasket is glued to or otherwise fixed to the outer surface of the first end cap. The first gasket is arranged to make a water tight seal with the water outlet seal surface and alternatively with the guide flange seal surface of the filter housing. A second compression gasket is fixed to the outer surface of the second end cap. The second gasket is also adapted to make a water tight seal with the guide flange seal surface and alternatively with the water outlet seal surface of the filter housing. The filter cartridge further may be installed within the filter housing in any one of two orientations including filter top side up and alternatively filter bottom side up.

### BRIEF DESCRIPTION OF THE DRAWINGS

FIG. 1 is a cross-sectional view of the filter housing of the prior art;

FIG. 2 is a cross-sectional view of the replacement cartridge of the present invention; and

FIG. 3 is a cross-sectional view of the cartridge filter of the present invention installed in the filter housing.

### DETAILED DESCRIPTION OF THE INVENTION

It is an object of the present invention to provide a unidirectional replaceable filter that will seal and function in a reverse or forward direction in the filter cartridge.

It is another object of the present invention to provide a replaceable filter with a maximum diameter that will fit within the sump of all standard ten inch filter housings.

It is yet another object of the present invention to accommodate the maximum center post length and diameter of all standard ten inch filter housings.

It is an additional object of the present invention to provide a filter that will properly form a watertight seal in all standard ten inch filter housings.

The present invention has been developed to address the above enumerated objects in that it provides a low cost replaceable, reversible, filter cartridge that has the appropriate diameter, center post accommodation feature, and length to satisfy the requirements of a universal fit filter for the ten inch standard filter housing. On example of such a replacement filter is the GE SmartWater™ True-Fit™ filter, model number FXULC, manufactured under license by the General Electric Company.

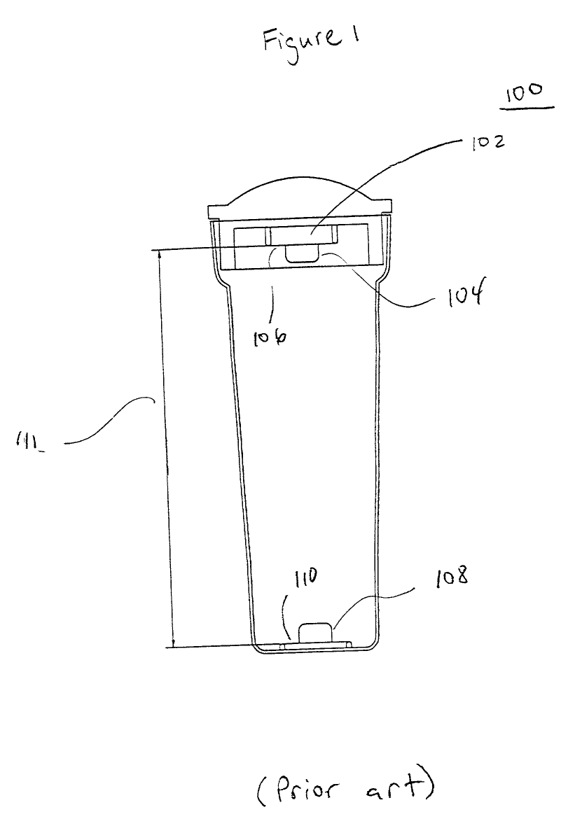

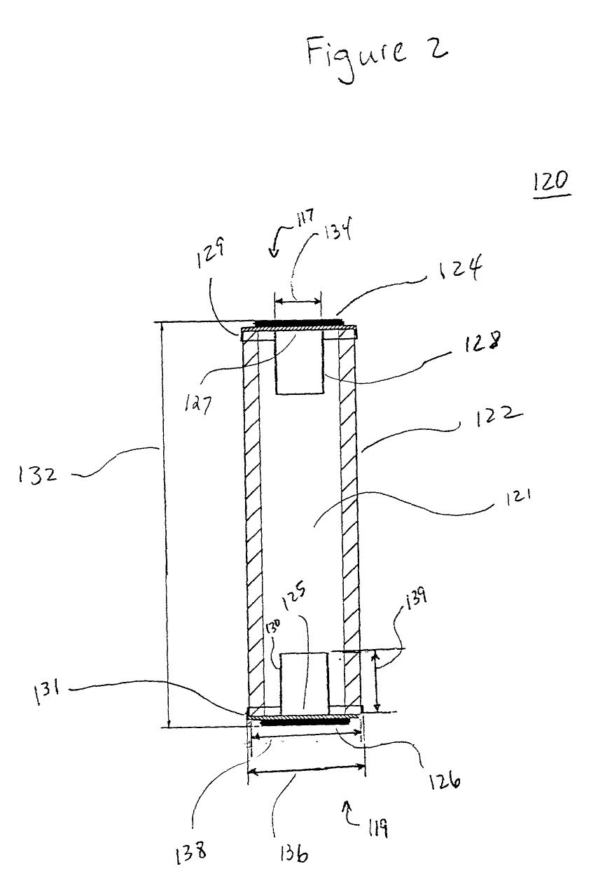

Referring now to FIGS. 1 and 2, wherein like elements have like reference numbers, the present invention is a replaceable filter cartridge assembly 120 for a standard water filter housing 100. The replaceable filter cartridge assembly 120 can be placed in a standard ten inch filter housing 100, the water filter housing 100 comprising a water outlet flange 104, a guide flange 108, a water outlet seal surface 106 and a guide flange seal surface 110.

The replaceable filter 120 comprises a subassembly including a closed outer cylindrical filter element 122 having a top 117 a bottom 119, and a side wall defining a chamber 121 therein. There is next a first circumferential end cap 129 fixed to the filter top 117. The first end cap 129 includes a first outlet port 127 having a wall section 128 being coupled at one end to the first outlet port 127 and extends into said chamber 121 and sized to encompass the water outlet flange 104 and the guide flange 108. The replaceable filter 120 also has a second circumferential end cap 131, substantially similar to the first end cap 129, fixed to said filter bottom 119. The second end cap 131 also includes a second outlet port 125 having a wall section 130 being coupled at one end to the second outlet port 125 and extending into the filter chamber 121. The second end cap wall 130 is sized to encompass the guide flange 108 and alternatively the water outlet flange 104. Next, a first compression gasket 124 is glued to or otherwise fixed to the outer surface of the first end cap 129. The first gasket 124 is arranged to make a water tight seal with the water outlet seal surface 106 and the guide flange seal surface 110 of the filter housing 100. A second compression gasket 126 is fixed to the outer surface of the second end cap 131. The second gasket 126 is adapted to make a water tight seal with the guide flange seal surface 110 and alternatively with the water outlet seal surface 106 of the filter housing 100. The filter cartridge 120 further may be installed within the filter housing 100 in any one of two orientations including the filter top side 117 up and alternatively the filter bottom side 119 up. In this specification the word “up” means the respective identified side of filter 120 being coupled to the water out flange 104 of filter housing 100.

The replaceable cartridge 120 is designed to be snuggly seated inside filter housing 100 by inserting the first and second end caps 129 and 131 on the water outlet flange 104 and the guide flange 108. The first and said second gaskets 124 and 126 together have a total compression at least equal to the difference between a filter fit length 111 and the total replaceable cartridge length 132, so as to provide a water tight seal between the filter cartridge 120 and the filter housing 100. The filter fit length 111 is equal to the distance between the water outlet seal surface 106 and the guide flange seal surface 110 of the filter housing 100.

In one exemplary embodiment the total length 132 of the filter cartridge 120 is in a range of about 9.760 to about 9.850 inches. The inside diameter 138 of the filter shell 122 is in a range from about 2.110 inches to about 2.170 inches. The outside diameter 136 of the first or the second end cap 129 or 131 is in a range from about 2.340 inches to about 2.360 inches. The inside diameter 134 of the first or second end cap 129 or 131 is in a range from about 0.975 inches to about 0.985 inches. The length 139 of the first or second end cap wall 128 or 130 is in a range from about 1.505 inches to about 1.525 inches. And the fit filter length 111 of the filter housing 100 is about 10 inches. Based on the above described exemplary dimension, the compression of the two compression gaskets 124 and 126 in one embodiment are about 0.150 inches to about 0.240 inches.

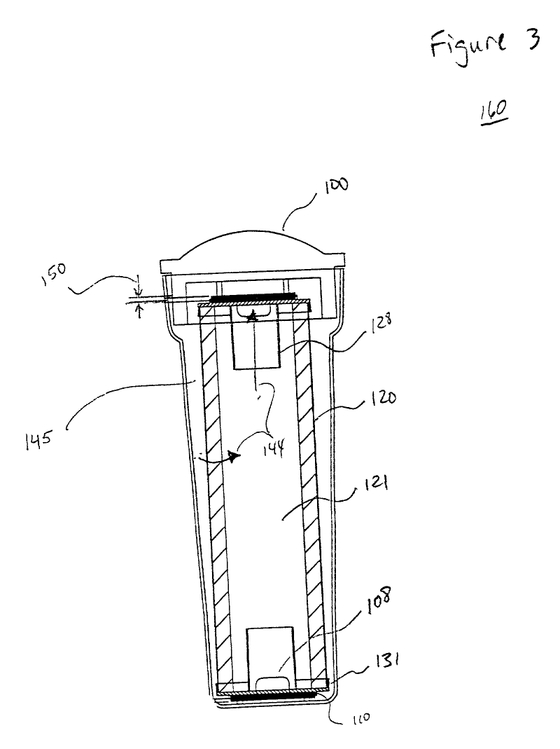

The present filter system 160, as illustrated in FIG. 3, is adapted to function as a water filtration system. Pressurized water is ported into the filter housing water inlet section 145. The water 144 is then force driven through the filter shell 122 into the replacement filter chamber 121. The inlet opening 125 of the second end cap is blocked by the guide flange 108 and guide flange seal surface 110 to prevent water from exiting the filter chamber 121 from the filter bottom 119. As such, the water 144 is forced to pass through the first end cap wall section 128. As the water 144 passes through the filter shell 122 water impurities are blocked from entering the filter chamber 121. After the water passes through the filter shell 122 it is collected and ported to an exit in the filter housing (not shown) to be made available for the user.

Different types of filter cartridges 120 block different types of impurities. For example, GE SmartWater TrueFit™ filter, model number FXUTC, is designed to remove chlorine. GE model numbers FXULC and FXSLC, which are designed to remove lead, cysts and chlorine. GE model number FXSVC, is designed to remove chlorine, lead, and volatile organic chemicals.

This invention provides advantages over the prior art, such as the water filtration system described in U.S. Pat. No. 4.626,350, Reid. First, this invention provides a replacement water filter 120 that can be inserted in the filter housing 100 in a forward and a reversible fashion (i.e. the top portion becomes the bottom and the bottom portion becomes the top), unlike the filter cartridge described in Reid. Next, the filter length, end cap inlet opening, end cap walls, and gasket compression of the present invention enable the present filter to fit into a standard 10 inch filter housing. Finally, the simplicity of the present design enable it to be cheaply and easily manufactured.

The present invention is a replacement filter 120 for a standard ten inch filter housing 100. This filter 120 employs dimension that enable it to easily replace standard ten inch filters. This replacement filter 120 can further be installed in a reversible fashion in filter housing 100.

It will be apparent to those skilled in the art that while the invention has been illustrated and described herein in accordance with the patent statutes, modifications and changes may be made in the disclosed embodiments without departing from the true spirit and scope of the invention. It is, therefore, to be understood that the appended claims are intended to cover all such modifications and changes as fall within the true spirit of the invention.

What is claimed is:

1. A replaceable filter cartridge assembly for a water filter housing, said water filter housing comprising a water outlet flange, a guide flange, a water outlet seal surface and a guide flange seal surface, said replaceable filter comprising:
a subassembly including a closed outer cylindrical filter having a top, a bottom, and a side wall defining a chamber therein;
a first end cap fixed to said filter top, wherein said first end cap includes a first outlet port having a wall section being coupled at one end to said first outlet port and extending into said chamber and sized to encompass the water outlet flange and the guide flange;
a second end cap, substantially similar to said first end cap, fixed to said filter bottom, wherein said second end cap includes an second outlet port having a wall section being coupled at one end to said second outlet port and extending into said chamber and sized to encompass the guide flange and the water outlet flange;
a first compression gasket being fixed to said outer surface of said first end cap, said first gasket adapted to make a water tight seal with the water outlet seal surface and the guide flange seal surface of the filter housing; and
a second compression gasket being fixed to said outer surface of said second end cap, said second gasket adapted to make a water tight seal with the guide flange seal surface and the water outlet seal surface of the filter housing;
wherein said filter cartridge further may be installed within the filter housing in any one of two orientations including said filter top side up and said filter bottom side up.

2. The replaceable cartridge, as recited in claim 1, wherein said first and said second gaskets together have a total compression at least equal to the difference between a filter fit length and the total replaceable cartridge length, so as to provide a water tight seal between said filter cartridge and the filter housing when said filter cartridge is installed in the filter housing.

3. The replaceable cartridge, as recited in claim 3, wherein said filter fit length is equal to the distance between the water outlet seal surface and the guide flange seal surface of the filter housing.

4. The replacement cartridge, as recited in claim 3, wherein the total compression is in a range from about 0.150 inches to about 0.240 inches.

5. A replaceable filter cartridge assembly for a water filter housing, said water filter housing comprising a water outlet flange, a guide flange, a water outlet seal surface and a guide flange seal surface, said replaceable filter comprising:
a subassembly including a closed outer cylindrical filter element having a top a bottom, and a side wall defining a chamber therein;
a first end cap fixed to said filter top, wherein said first end cap includes a first inlet port having a wall section being coupled at one end to said first inlet port and extending into said chamber and sized to encompass the water outlet flange and the guide flange;
a second end cap, substantially similar to said first end cap, fixed to said filter bottom, wherein said second end cap includes an second inlet port having a wall section being coupled at one end to said second inlet port and extending into said chamber and sized to encompass the guide flange and the water outlet flange;
a first compression gasket being fixed to said outer surface of said first end cap, said first gasket adapted to make a water tight seal with the water outlet seal surface and the guide flange seal surface of the filter housing; and
a second compression gasket being fixed to said outer surface of said second end cap, said second gasket adapted to make a water tight seal with the guide flange seal surface and the water outlet seal surface of the filter housing;
wherein said filter cartridge further may be installed within the filter housing in any one of two orientations including said filter top side up and said filter bottom side up;
wherein said first and said second gaskets together have a total compression at least equal to the difference between a filter fit length and the total replaceable cartridge length, so as to provide a water tight seal between said filter cartridge and the filter housing when said filter cartridge is installed in the filter housing.

6. The replaceable cartridge, as recited in claim 5, wherein said filter fit length is equal to the distance between the water outlet seal surface and the guide flange seal surface of the filter housing.

7. The replacement cartridge, as recited in claim 6, wherein the total compression is in a range from about 0.150 inches to about 0.240 inches.
